(19) United States
(12) Patent Application Publication
(10) Pub. No.: US 2024/0052842 A1
(43) Pub. Date: Feb. 15, 2024

(54) COMPRESSOR AND ROTOR MODULE FOR A COMPRESSOR

(71) Applicant: BorgWarner Inc., Auburn Hills, MI (US)

(72) Inventors: Silvio Koch, Kirchheimbolanden (DE); Marcel Berrang, Schweisweiler (DE); Patrick Steingass, Alzey (DE)

(21) Appl. No.: 18/217,702

(22) Filed: Jul. 3, 2023

(30) Foreign Application Priority Data
Aug. 15, 2022 (DE) 102022120532.0

(51) Int. Cl. F04D 25/06; F04D 17/10; F04D 29/053

(52) U.S. Cl. CPC F04D 25/0606; F04D 17/10; F04D 29/053; H02K 7/003

(57) ABSTRACT

A compressor includes a rotor module (10) which incorporates a compressor wheel (11) and a rotor (12) of an electric motor. The compressor also includes a stator (2) of the electric motor. The rotor module (10) has a hollow shaft (14). The rotor module (10) for the compressor is also included.

### CROSS-REFERENCE TO RELATED APPLICATION

This application claims priority pursuant to 35 U.S.C. 119(a) to German Patent Application No. 102022120532.0 filed Aug. 15, 2022, which application is incorporated herein by reference in its entirety.

### BACKGROUND

The invention relates to a compressor with the features specified in the preamble of Claim 1, as are of known art from DE 11 2012 002 901 T5. Such compressors are required, for example, for the efficient operation of fuel cells to which compressed air must be supplied.

A compressor is a device for the compression of gases, and comprises a compressor wheel, which is driven by an electric motor that comprises a rotor and a stator. Compressors may also comprise other parts, e.g. a turbine. The compressor wheel and rotor are part of a rotating assembly that is called a rotor module.

### SUMMARY

An object of the present invention is to show how the energy efficiency of compressors can be improved.

This object is achieved by means of a compressor with the features listed in Claim 1, and by means of a rotor module for such a compressor. Advantageous refinements of the invention are the subject matter of dependent claims.

A rotor module in accordance with the invention has a hollow shaft, via which the electric motor drives the compressor wheel. A rotor module in accordance with the invention therefore has an advantageously low mass, which enables a more energy-efficient operation.

In an advantageous refinement of the invention the rotor comprises permanent magnets that are arranged in the hollow shaft. In this way, the shaft can be utilised as a rotor housing, and thus the number of components required for the rotor module can advantageously be reduced.

In another advantageous refinement of the invention the hollow shaft has a hollow section on both sides of the rotor. In this way, the weight of the rotor module can be reduced even further. Here the hollow sections of the hollow shaft on both sides of the rotor can have a diameter corresponding to the diameter of the rotor. They may, for example, be cylindrically shaped over a length that is at least twice the length of the rotor.

A further advantageous refinement of the invention the hollow shaft comprises three sections joined by welding. In this way, a simple and cost-effective production is possible. A central section of the hollow shaft can form the rotor of the electric motor, that is to say, it can carry the permanent magnets. Sections can be connected to the central section on both sides; these are designed, for example, as cylindrical sleeves, and in particular have a sleeve base with an opening. The sleeve base facilitates the coupling of the compressor wheel to the hollow shaft; the opening on the sleeve base may, for example, have an internal thread, and the compressor wheel can be fastened to the hollow shaft by means of a screw that projects into the opening. Alternatively, the compressor wheel may also be welded to the hollow shaft.

Further details and advantages are explained in examples of embodiment of the invention, with reference to the accompanying figures. In these figures identical and corresponding components are designated with matching reference numbers.

### BRIEF DESCRIPTION OF THE DRAWINGS

FIG. 1 shows a compressor;

FIG. 2 shows the rotor module of the compressor; and

FIG. 3 shows another example of embodiment of a rotor module.

### DETAILED DESCRIPTION

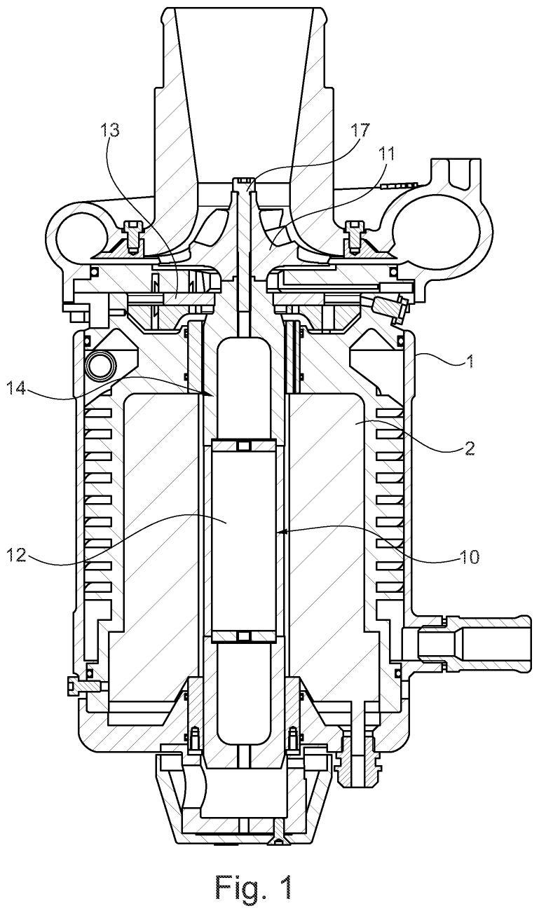

FIG. 1 shows schematically a compressor, which has a housing 1, in which a rotor module 10, which comprises a compressor wheel 11 and a rotor 12 of an electric motor, and a stator 2 are arranged. The rotor 12 and the stator 2 together form an electric motor, with which the compressor wheel 11 is driven. In the example of embodiment illustrated, the compressor has only a single compressor wheel 11. However, it is also possible to provide a compressor wheel at both ends of the compressor. The rotor module of a compressor may therefore also incorporate two compressor wheels.

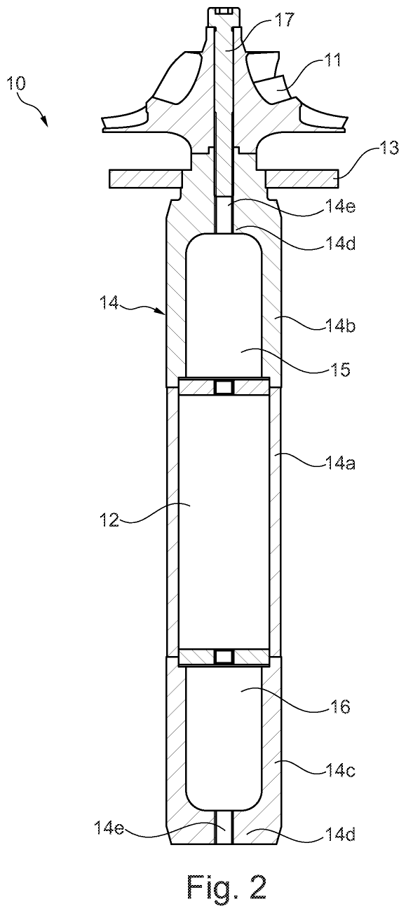

FIG. 2 shows the rotor module 10 of the compressor in detail. As can be seen in this figure, the rotor module 10 comprises a hollow shaft 14, via which the compressor wheel is driven. The rotor 12 is thus coupled to the compressor wheel 11 via the hollow shaft 14. In the example of embodiment shown in FIG. 2, there is in the hollow shaft 14 a cavity 15, 16 on both sides of the rotor 12. In the region of the cavities 15, 16, the external diameter of the hollow shaft 14 is generally the same as the external diameter of the hollow shaft in the region of the rotor 12, and deviates from the latter by no more than 5%, for example by 2% or less.

The hollow shaft 14 comprises three sections welded together. The central section 14a of the hollow shaft 14 forms the rotor 12 of the electromagnet. End sections 14b, 14c of the hollow shaft 14 adjoin the central section 14a on both sides, and each has a base 14d. The end sections 14b, 14c are welded to the central section 14a and in each case have an opening 14e in their base 14d. These openings 14e enable pressure equalization when the various sections 14a, 14b, 14c of the hollow shaft 14 are welded together. After welding, the openings 14e may be closed, for example by means of a screw 17, with which the compressor wheel 11 is fixed to the hollow shaft 14. The openings 14e may be provided with an internal thread for this purpose.

Especially if the rotor module 10 comprises a compressor wheel 11 at each of its two ends, the two end sections 14b, 14c of the hollow shaft 14 may be of identical design to simplify production.

The sections 14a, 14b, 14c may be butt-jointed, for example they can be welded together by means of a butt seam or a Y-seam. Alternatively, the sections may also be inserted into each other and welded, for example, by means of a perforated seam.

Over most of its length, the hollow shaft 14 has the shape of a cylinder. In the example of embodiment shown, this cylinder is formed by the central section and the greater part of the sleeves welded to the central section.

The rotor 12 of the electric motor has permanent magnets which, in the example of embodiment shown, are arranged inside the hollow shaft 14. The hollow shaft 14 thus forms a housing for the rotor 12. Alternatively or additionally, permanent magnets can also be located on the outside of the hollow shaft 14.

The rotor module 10 may comprise an annular disk 13 between the compressor wheel 11 and the rotor 12. The rotor module 10 may be axially mounted on this annular disk 13. In addition, radial bearings may be provided for the rotor module 10, in particular in order to support the hollow shaft 14 at its two end sections 14b, 14c. The hollow shaft 14 may thus supported on both sides of the rotor 12, for example with air bearings or magnetic bearings. For example, radial mounting may be provided at regions of the hollow shaft 14, whose diameter corresponds to the diameter of the rotor 12.

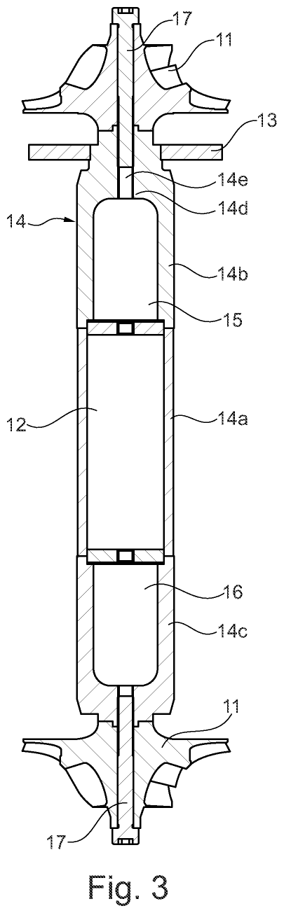

FIG. 3 shows another example of embodiment of a rotor module which differs from the above-described example of embodiment only in that a compressor wheel 11 is attached at both ends of the hollow shaft 14. The second compressor wheel 11, like the first compressor wheel 11, may be provided for the compression of gas, or may form an expander stage, that is to say, it can be used to generate electrical energy by the expansion of gas; in which case the electric motor of the compressor is then operated as a generator.

### LIST OF REFERENCE SYMBOLS

1 Housing
2 Stator
10 Rotor module
11 Compressor wheel
12 Rotor
13 Annular disk
14 Hollow shaft
14a Section of the hollow shaft
14b End section of the hollow shaft
14c End section of the hollow shaft
14d Base
14e Opening
15 Cavity
16 Cavity
17 Screw

What is claimed is:

1. A compressor comprising;
a rotor module, which comprises a compressor wheel and a rotor of an electric motor, and
a stator of the electric motor,
characterised in that the rotor module comprises a hollow shaft.

2. The compressor according to claim 1, characterised in that the rotor comprises permanent magnets that are arranged in the hollow shaft.

3. The compressor according to claim 1, characterised in that the hollow shaft has a hollow section on both sides of the rotor.

4. The compressor according to claim 3, characterised in that on the hollow sections on both sides of the rotor, the hollow shaft has a diameter that matches a diameter of the rotor.

5. The compressor according to claim 1, characterised in that the hollow shaft comprises three sections that are welded together.

6. The compressor according to claim 5, characterised in that the hollow shaft is radially mounted on its end sections.

7. The compressor according to claim 5, characterised in that a central section of the hollow shaft carries permanent magnets and forms the rotor, while two sections adjoining the central section are sleeves that each have a base with an opening.

8. The compressor according to claim 7, characterised in that the hollow shaft is radially mounted on its end sections.

9. The compressor according to claim 1, characterised in that the hollow shaft between the compressor wheel and the rotor carries an annular disk, on which the rotor module is axially mounted.

10. The compressor according to claim 1, characterised in that the compressor wheel is fixed to the hollow shaft by a screw.

11. The compressor according to claim 1, characterised in that the compressor wheel is attached at both ends of the hollow shaft.

12. The compressor according to claim 1, characterised in that the compressor wheel is attached at one end of the hollow shaft, and an expander stage is attached at the other end of the hollow shaft.

13. The compressor according to claim 2, characterised in that the hollow shaft has a hollow section on both sides of the rotor.

14. The compressor according to claim 13, characterised in that on the hollow sections on both sides of the rotor, the hollow shaft has a diameter that matches a diameter of the rotor.

15. The compressor according to claim 13, characterised in that the hollow shaft between the compressor wheel and the rotor carries an annular disk, on which the rotor module is axially mounted.

16. The compressor according to claim 13, characterised in that the compressor wheel is attached at one end of the hollow shaft, and an expander stage is attached at the other end of the hollow shaft.

17. A rotor module for a compressor, the rotor module comprising;
a rotor of an electromagnet, and
a compressor wheel,
characterised in that the rotor module has a hollow shaft.
